(19) United States
(12) Patent Application Publication
(10) Pub. No.: US 2017/0199994 A1
(43) Pub. Date: Jul. 13, 2017

(54) IMAGING DEVICES AND METHODS FOR AUTHENTICATING A USER

(71) Applicant: Microsoft Technology Licensing, LLC, Redmond, WA (US)

(72) Inventors: Emanuel Shalev, Redmond, WA (US); Sagi Katz, Yokneam Ilit (IL); Eliyahu Schwartz, Haifa (IL)

(21) Appl. No.: 14/995,025

(22) Filed: Jan. 13, 2016

(51) Int. Cl. G06F 21/31

(52) U.S. Cl. CPC G06F 21/316

(57) ABSTRACT

A method for authenticating a user. The method includes the act of recording first data about an environment at a first time. A user interaction with the environment is stored as a stored password. Second data about the environment is received through an image sensor at a second time. While receiving the second data about the environment, a password is entered. The entered password is compared with the stored password.

### BACKGROUND

### Background and Relevant Art

The subject matter claimed herein is not limited to embodiments that solve any disadvantages or that operate only in environments such as those described above. Rather, this background is only provided to illustrate one exemplary technology area where some embodiments described herein may be practiced.

Authentication of users typically involves entering a password with a keyboard. Passwords are typically complex. Biometric login devices partly solve this problem by requiring no password. However, sometimes it is desired to easily share a single account. Picture passwords may be less secure and typically do not allow location based login. Therefore, some parts of the population, such as children, may have trouble with using secure login systems.

### BRIEF SUMMARY

One embodiment illustrated herein includes a method for authenticating a user. The method includes at a first time, recording first data about an environment. A user interaction with the environment is stored as a stored password. At a second time, second data about the environment is received through an image sensor. While receiving the second data about the environment, a password is entered. The entered password is compared with the stored password.

One embodiment illustrated herein includes a method for authenticating a user. At a first time, one or more feature points and descriptors in an environment is recorded. While recording one or more feature points and descriptors about the environment, a user interaction with the environment relative to the recorded one or more feature points and descriptors is stored as a stored password. At a second time, one or more feature points and descriptors in the environment are received through an image sensor. While receiving one or more feature points and descriptors in the environment, a password is entered relative to the received one or more feature points and descriptors in the environment. The one or more feature points and descriptors in the entered password are compared with the one or more feature points and descriptors in the stored password.

One embodiment illustrated herein includes an imaging device for authenticating a user. The imaging device includes a processor, an image sensor in electronic communication with the processor, and memory in electronic communication with the processor. The memory includes instructions executable by the processor to record first data about an environment at a first time. A user interaction with the environment is stored as a stored password. At a second time, second data about the environment is received through an image sensor. While receiving the second data about the environment, an entered password is received. The entered password is compared with the stored password.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a method for authenticating a user;

FIG. 2 is a conceptual drawing of a user in an environment;

FIG. 3 illustrates a perspective view of the handheld imaging device of FIG. 2 with multiple interactions with the display; and

FIG. 4 illustrates a perspective view of the wearable imaging device of FIG. 2.

### DETAILED DESCRIPTION

At least one embodiment disclosed herein describes a method for authenticating a user. The method may use an imaging device to recognize points in the real world and use those points to later authenticate a user. At least one embodiment described herein may store a password based on a user's interactions with the environment and authenticate a password based on the user's subsequent interactions with the same or a similar environment.

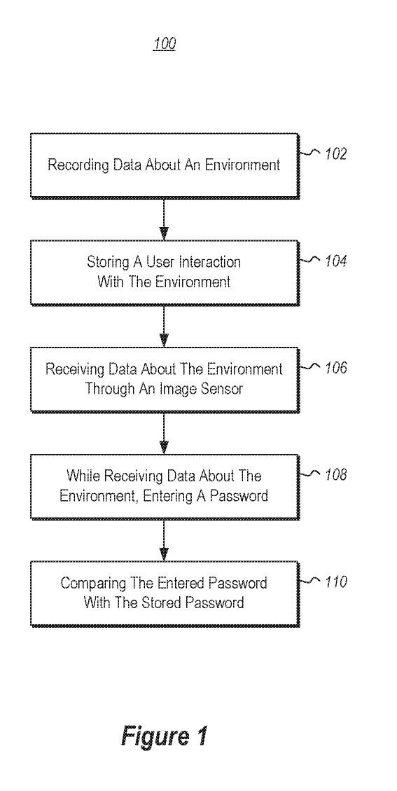

FIG. 1 illustrates a method 100 for authenticating a user. The method 100 may include an act of recording 102 data about the environment. Data about the environment recorded at a first time may include first data. A user interaction with the environment may be stored 104. Data about the environment may be received 106 through an image sensor. Data about the environment received at a second time may include second data. While receiving data about the environment, a password may be entered 108. The entered password may be compared 110 with the stored password. The act of recording 102 data about the environment and storing 104 a user interaction with the environment may be considered the password storage phase, the act of receiving 106 data about the environment through an image sensor and (while receiving data about the environment) entering 108 a password may be considered the password entry phase, and the act of comparing 110 the entered password with the stored password may be considered the password authentication phase.

In at least one embodiment, entering 108 a password while receiving data about the environment may exclude entering a password over a still image. For example, a typical picture password may take a picture of the environment, then the user may interact with the picture (e.g., by tapping and/or drawing on the picture) as the password. The picture used for the password may be taken from a single perspective and/or at a single time and the password may be stored and entered from that same perspective (e.g. over top of the picture). At least one embodiment disclosed herein may differ from a typical picture password based on a difference in perspective between the stored password and the entered password. In another example, the data may be received 106 from more than one locations. For instance, the image sensor may be moving while data is being received 106.

At least one embodiment disclosed herein may differ from a typical picture password based on a difference in time period during the storing and/or entering of a password. Receiving 106 data about the environment may include receiving data about the environment in real time. For example, the image sensor may be capable of recording video. Thus, receiving 106 data may mean not simply receiving information at a single time (e.g., a still image and/or information about the still image), but receiving data over a period of time.

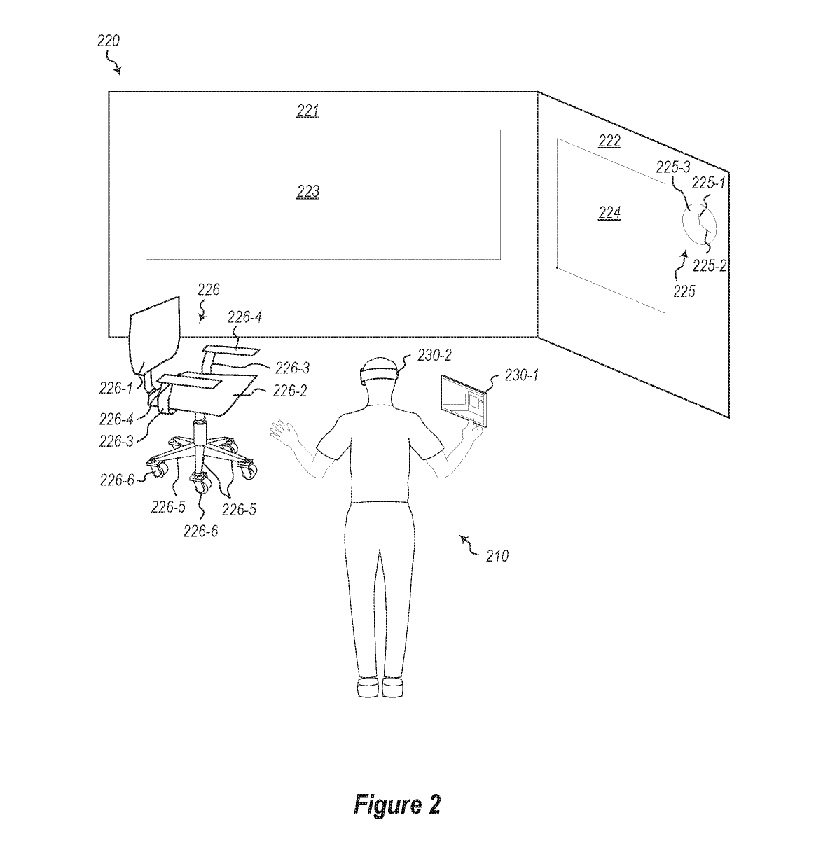

At least one embodiment described herein may store 104 a password based on a user's interactions with the environment and may enter 108 and authenticate 110 a password based on a user's subsequent interactions with the environment. Thus, FIG. 2 is a conceptual drawing of a user 210 in an environment 220. FIG. 2 is provided as an example of an embodiment where at least one method described herein may be performed.

The user 210 is shown with one or more imaging devices. Imaging devices may include a tablet computer, a laptop computer, a mobile telephone, a camera with user input, other handheld imaging devices, a desktop computer with an imaging device, a server with an imaging device, a head mounted imaging device, other wearable imaging devices, or combinations thereof. The user 210 is illustrated using both a handheld imaging device 230-1 and a wearable imaging device 230-2. Examples of the method 100 of FIG. 1 will be described in connection with the example of an environment 220 in FIG. 2 throughout and will be referenced by their respective element numbers. For example, one or more imaging devices (e.g., handheld imaging device 230-1 and/or wearable imaging device 230-2) may be used to record 102 data about the environment 220, to store 104 a user interaction with the environment 220, to receive 106 data about the environment 220, to enter 108 a password (e.g., while receiving 106 data about the environment 220), to compare 110 the entered password with the stored password, or combinations thereof.

The environment 220 may include environmental features. The environmental features may be assigned feature points and/or descriptors. At least a portion of one or more environmental features, feature points, descriptors, or combinations thereof may be used for recording 102 data about an environment, storing 104 a user interaction with the environment, receiving 106 data about the environment through an image sensor, entering 108 a password, or combinations thereof. By way of illustration, the environment 220 is shown with multiple environmental features. A first wall 221 and a second wall 222 with a white board 223 on the first wall 221 and a pin board 224 a clock 225 on the second wall 222, and a chair 226, are examples of environmental features. In other embodiments, more or fewer environmental features may be included.

A feature point may include any meaningful pattern in color, intensity, or geometric structure. For example, a meaningful geometric structure may include points relative to an object, such as a corner of an object, an intersection of one or more edges and/or lines, or other points relative to an object, or combinations thereof. As shown in FIG. 2, the environmental features (e.g., the first wall 221, second wall 222, white board 223, pin board 224, clock 225, and chair 226) include feature points. Some objects in the environment 220 may include more or fewer feature points. For example, the feature points in the environment 220 may include the four corners (not labeled) of the first wall 221, the second wall 222, the white board 223, and the pin board 224, the ends (e.g., at the intersection of the hands 225-1, 225-2 and at the ends furthest from the intersection of the hands 225-1, 225-2) of each hand 225-1, 225-2 of the clock, and the intersection between the hands 225-1, 225-2 of the clock 225. The chair 226 may include multiple feature points. For example, the chair back 226-1 includes four corners (not labeled), the seat 226-2 includes four corners (not labeled), the arms 226-3 each include four corners (not labeled), the arm rests 226-4 each include four corners (not labeled), each of the four legs 226-5 include four corners (not labeled), and each intersection (not labeled) of the wheels 226-6 with their respective legs 226-5 all of which may be feature points.

A descriptor may include a relationship between the feature point and one or more feature points in the environment 220. For example, the descriptor may include a relationship between feature points and/or other environmental features of the environment. As shown in FIG. 1, a descriptor for the intersection of the hands 225-1, 225-2 of the clock 225 may include a distance from the intersection to an outermost edge of the clock face 225-3, a distance from the end of the minute hand 225-1, a distance from the end of the hour hand 225-2, the surface area of the clock face 225-3, other relationships between various features of the clock, or combinations thereof and/or relationships between the intersection of the hands 225-1, 225-2 of the clock 225 and other feature points in the environment 220.

A descriptor may describe a visual look of an area. For example, a descriptor may include an area around the feature point (e.g., the descriptor may be ten by ten pixels around the feature point).

Recording 102 data about the environment 220 and/or receiving 106 data about the environment 220 through an image sensor may include storing information about one or more environmental features and/or portions of the environmental features. For example, the method 100 for authenticating a user 210 may include storing information about at least a portion (e.g., all or fewer than all) of the first wall 221, the second wall 222, the white board 223, the pin board 224, the clock 225, the chair 226, or combinations thereof.

One or more feature points of the environmental features may be stored as a part of recording 102 data about the environment 220 and/or as a part of receiving 106 data about the environment 220. For example, the corners and/or ends of the first wall 221, the second wall 222, the white board 223, the pin board 224, the clock 225, the chair 226, or combinations thereof may be stored as feature points.

One or more descriptors of the feature points may be stored as a part of recording 102 data about the environment 220 and/or as a part of receiving 106 data about the environment 220. For example, a distance between an upper left corner (not labeled) of the white board 223 and the lower right corner (not labeled) of the pin board 224 may be stored as a descriptor. In another example, a distance from the front right corner (not labeled) of the right arm rest 226-4 and the upper left corner (not labeled) of the chair back 226-1 may be stored as a descriptor. In a further example, an angle (not labeled) of a line (not labeled) between the lower right corner (not labeled) and the upper right corner (not labeled) of the chair back 226-1 and a line (not labeled) between the front right corner (not labeled) and the back right corner (not labeled) of the seat 226-2 may be stored as a descriptor.

A user (e.g., user 210) interaction with the environment 220 may be stored 104. Examples of user interactions that may be stored 104 are described below. The user 210 may interact with the environment 220. For example, the user 210 may move within the environment 220. Moving within the environment may include standing, sitting, turning, and the like.

Interacting with the environment 220 may depend upon the imaging device used. For example, user interactions with the environment 220 using a handheld imaging device 230-1 may differ, at least in part, from user interactions with the environment 220 using a wearable imaging device 230-2.

The following is an example of user interactions with the environment 220 using a handheld imaging device 230-1 that may be stored 104 as a stored password and/or entered 108 a password. The handheld imaging device 230-1 may include a display 232-1. The display 232-1 may be in electronic communication with an image sensor (not shown). The display 232-1 may act as both a display and an input device. For example, the display 232-1 may include sensors that detect the user's touch.

The user 210 may position the handheld imaging device 230-1 within the environment 220 in a first position. For example, as shown in FIG. 2, the user 210 has positioned the handheld imaging device 230-1 relative to one or more environmental features (e.g., a portion of the first wall 221, a portion of the white board 223, a portion of the second wall 222, the entire pin board 224, and the entire clock 225).

The user's interactions with the environment may be stored 104 and/or entered 108 a password based on input provided to an imaging device. The user 210 may provide input to the handheld imaging device 230-1 through, for example, the display 232-1. In one example, the user 210 may tap on the display 232-1. In another example, the user 210 may draw (e.g., a line, ellipse, or other shape).

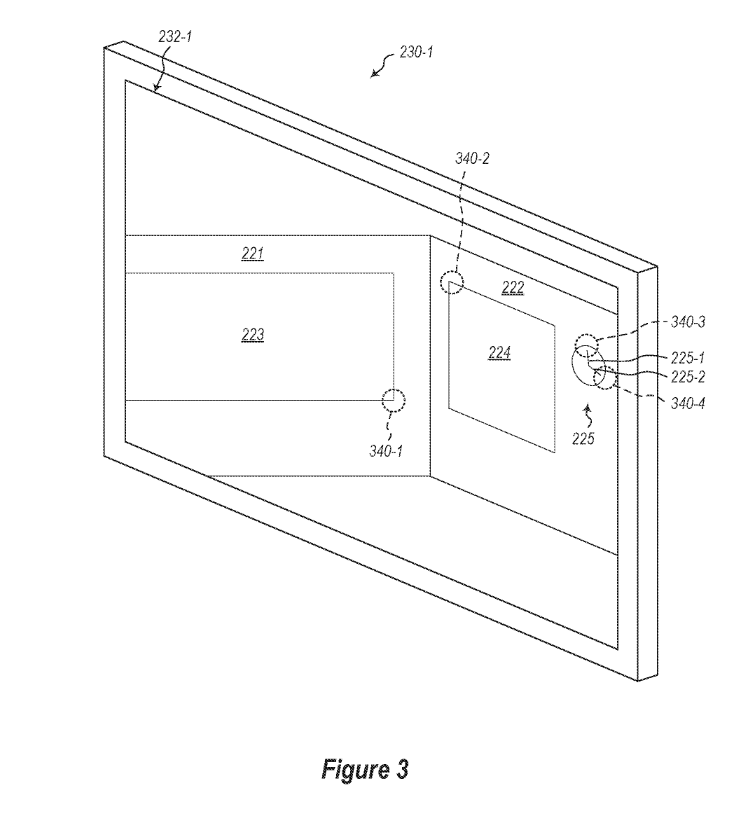

FIG. 3 illustrates a perspective view of the handheld imaging device 230-1 with multiple interactions with the display 232-1. As shown, the user 210 has touched the display 232-1 in four locations: the first touch 340-1 at the bottom right corner of the white board 223, the second touch 340-2 at the upper left corner of the pin board 224, the third touch 340-3 on the end of the minute hand 225-1, and the fourth touch on the end of the hour hand 225-2. Various aspects of the touches 340 may be stored. For example, the handheld imaging device 230-1 may assign each touch to a feature point. In another example, the handheld imaging device 230-1 may assign descriptors to each feature point relative to other feature points and/or the other touches 340. In some embodiments, the order of the touches 340 may be stored. In the example of FIG. 3, the position of the handheld imaging device 230-1 remains substantially unchanged while interacting with the environment 220 during storage 104 of the user interaction and/or entering 108 of a password. In other embodiments, more or fewer touches may be used.

Although each touch 340 is illustrated as a single point touch with a single finger, one or more embodiments may include one or more touches with one or more fingers, may include touches that extend beyond a single point (e.g., a touch that forms a shape, such as a line, circle, polygon, or other shape). For example, a user may touch the screen with two fingers at the same time for a single touch 340. In another example, the user may draw a circle on the display with two fingers for a single touch 340.

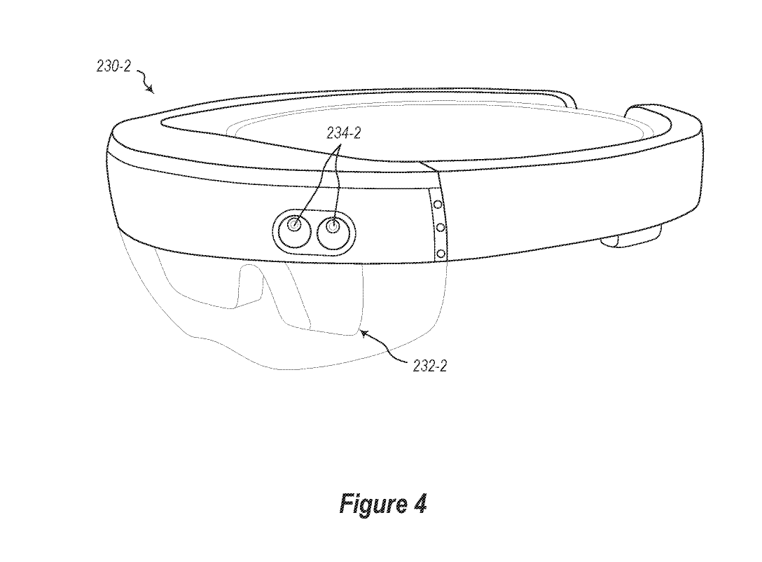

The following is an example of user interactions with the environment 220 using a wearable imaging device 230-2 that may be stored 104 as a stored password and/or entered 108 as a password. The wearable imaging device 230-2 is shown in greater detail in FIG. 4. The wearable imaging device 230-2 may include a display 232-2. The display 232-2 may be in electronic communication with one or more image sensors 234-2 that may receive data about the environment 220. The image sensors 234-2 may be located on the front (e.g., away from the user) of the wearable imaging device 230-2. The image sensors 234-2 may act as an input device. For example, as the user interacts with the environment, the image sensors 234-2 may store the user's interactions as input (e.g., that may be stored 104 as a stored password and/or entered 108 as an entered password).

The user 210 may position the wearable imaging device 230-2 within the environment 220 in a first position. For example, as shown in FIG. 2, the wearable imaging device 230-2 is positioned relative to one or more environmental features (e.g., a portion of the first wall 221, a portion of the white board 223, and the entire chair 226). As with the handheld imaging device 230-1, the wearable imaging device 230-2 may record 102/108 data about the environment using the image sensor 234-2.

The user's interactions with the environment may be stored 104 and/or entered 108 as a password based on input provided to an imaging device. The user 210 may provide input to the wearable imaging device 230-2 through, for example, the image sensors 234-2. In one example, the user 210 aim the wearable imaging device 230-2 (e.g., position the image sensors 234-2) toward an object (e.g., at least a portion of an environmental feature). In another example, the user 210 aim the wearable imaging device 230-2 at an object and interact with the object. For instance, as shown in FIG. 2, the user 210 may gesture (e.g., point) toward an object (e.g., the chair 226) Aiming at and/or gesturing toward an object may indicate to the wearable imaging device 230-2 to store 104 the interaction (e.g., pointing at an object). In a further example, the user 210 may aim the wearable imaging device 230-2 toward an object and provide direct input to the wearable imaging device 230-2 by, for example, touching a button (not shown) on the wearable imaging device 230-2.

The following is an example of storing 104 user interactions with the environment and/or entering 108 a password based on gestures provided to the wearable imaging device 230-2. As shown in FIG. 2, the user 210 is gesturing toward an environmental feature, the chair 226. The user 210 may gesture toward feature points in the environmental feature. For example, the user 210 may point at the top right corner (not labeled) of the chair back 226-1 of chair 226, then the user 210 may point at the front right corner (not labeled) of the right arm rest 226-4 of the chair 226, then the user 210 may point at one of the wheels 226-6, and then the user 210 may point at the bottom left corner (not labeled) of the white board 223. The wearable imaging device 230-2 may store 104 these user interactions (e.g., the gestures toward at least a portion of an environmental feature) as the stored password. In some embodiments, the user 210 may point at a portion of the environmental feature that is not a feature point. For example, the user may simply point at the chair back 226-1 of the chair 226.

Thus, for this example of storing 104 a password with the user's interactions with the environment 220 as a stored password, the stored password may include various aspects of the environment 220 and/or the user interactions with the environment 220. For example, the stored password may include the position of the imaging device (e.g., at the time of interacting with an environmental feature), may include the number, location, order of gestures and/or inputs, or combinations thereof, may include other aspects of the imaging device and/or the user's interaction with the imaging device in the environment, or combinations thereof.

In the examples described above, the position of the imaging devices may be unchanged while the user interacts with the environment. In other embodiments, the position of the imaging device may change and/or may stay the same between and/or during one or more user interactions with the environment 220. By way of example, referring back to FIG. 2, the position of the handheld imaging device 230-1 and/or the wearable imaging device 230-2 may change between and/or during one or more touches of the display 232-1, gestures and/or inputs with the image sensors 234-2, or combinations thereof. For instance, in addition to the first through fourth touches shown in FIG. 3, the user 210 may move the handheld imaging device 230-1 to point toward (e.g., be positioned such that the image sensor receives data about and displays) the chair 226 and may provide a fifth touch (not labeled) on the display 232-1 on the upper left corner (not labeled) of the chair back 226-1 of the chair 226. In another example, in addition to the four gestures provided in the example using a wearable imaging device 230-2 described above, the user's head may turn toward the second wall 222 and the user may gesture (e.g., point) toward the minute hand 225-1 of the clock 225.

Referring back to FIG. 1, after the user interactions are stored 104 as the stored password, the password entry phase may begin. An image sensor on the imaging device may receive 106 data about the environment (e.g., environment 220). Receiving 106 data about the environment may include receiving data about environmental features that may include feature points and/or descriptors for at least a portion of one or more environmental features.

While receiving 106 data about the environment, a password may be entered 108. Entering 108 the password may be similar to storing 104 a user interaction with the environment. For example, a user (e.g., user 210 and/or another user) may interact with the environment while an image sensor (e.g., image sensor 234-2) receives 106 data about the environment. Thus, the discussion regarding storing 104 a user interaction with the environment applies to entering 108 the password, as shown above.

At least one embodiment described herein may be capable of authenticating a user in the same environment, but in a different initial position. For example, as shown in FIG. 2, the user 210 is in an initial position. While in this initial position, the data about the environment 220 may be recorded 102 and the user interaction with the environment 220 may be stored 104 as a stored password. The user 210 may move to different position within the environment 220 while one or more of data about the environment 220 is received 106 through an image sensor or a password is entered 108 (while receiving data about the environment 220). By moving to a different position within the environment 220, for example, an image shown to the user 210 (e.g., by the display 232-1 of the handheld imaging device 230-1 or by a display 232-2 of the wearable imaging device 230-2) while storing 104 the user's interactions with the environment 220 would be different (e.g., from a different perspective) than an image shown to the user 210 while entering 108 a password.

Thus, in at least one embodiment, an image and/or data recorded and/or stored during a password storage phase (e.g., while the data about the environment 220 may be recorded 102 and the user interaction with the environment 220 may be stored 104 as a stored password) may be different from an image and/or data recorded and/or stored during a password entry phase. In other words, an image shown to the user 210 while storing 104 the user's interactions with the environment 220 would be different (e.g., from a different perspective) than an image shown to the user 210 while entering 108 a password). For example, at a first time the user 210 may stand in the position shown in FIG. 2 while the data about the environment 220 may be recorded 102 and the user interaction with the environment 220 may be stored 104 as a stored password and at a second time, the user 210 may sit on the chair 226 while receiving 106 data about the environment through an image sensor (e.g., on one or more of the handheld imaging device 230-1 or the wearable imaging device 230-2) and entering 108 a password.

The user's interactions with the environment may be stored 104 and/or entered 108 as a password based on input provided to an imaging device. The user 210 may provide input to the wearable imaging device 230-2 through, for example, the image sensors 234-2. In one example, the user 210 aim the wearable imaging device 230-2 (e.g., position the image sensors 234-2) toward an object (e.g., at least a portion of an environmental feature). In another example, the user 210 aim the wearable imaging device 230-2 at an object and interact with the object. For instance, as shown in FIG. 2, the user 210 may gesture (e.g., point) toward an object (e.g., the chair 226) Aiming at and/or gesturing toward an object may indicate to the wearable imaging device 230-2 to store 104 the interaction (e.g., pointing at an object). In a further example, the user 210 may aim the wearable imaging device 230-2 toward an object and provide direct input to the wearable imaging device 230-2 by, for example, touching a button (not shown) on the wearable imaging device 230-2.

The following is an example of storing 104 user interactions with the environment and/or entering 108 a password based on gestures provided to the wearable imaging device 230-2. As shown in FIG. 2, the user 210 is gesturing toward an environmental feature, the chair 226. The user 210 may gesture toward feature points in the environmental feature. For example, the user 210 may point at the top right corner (not labeled) of the chair back 226-1 of chair 226, then the user 210 may point at the front right corner (not labeled) of the right arm rest 226-4 of the chair 226, then the user 210 may point at one of the wheels 226-6, and then the user 210 may point at the bottom left corner (not labeled) of the white board 223. The wearable imaging device 230-2 may store 104 these user interactions (e.g., the gestures toward at least a portion of an environmental feature) as the stored password. In some embodiments, the user 210 may point at a portion of the environmental feature that is not a feature point. For example, the user may simply point at the chair back 226-1 of the chair 226.

Thus, for this example of storing 104 a password with the user's interactions with the environment 220 as a stored password, the stored password may include various aspects of the environment 220 and/or the user interactions with the environment 220. For example, the stored password may include the position of the imaging device (e.g., at the time of interacting with an environmental feature), may include the number, location, order of gestures and/or inputs, or combinations thereof, may include other aspects of the imaging device and/or the user's interaction with the imaging device in the environment, or combinations thereof.

After the password entry phase, password authentication phase may begin. The entered password may be compared 110 with the stored password. Comparing 110 the entered password with the stored password may include comparing the environmental features indicated in the entered password with the environmental features indicated in the stored password. For instance, if the stored password was the pin board 224, then the clock 225, and then the chair 226 and the entered password was the same, then the entered password would be authenticated.

Comparing 110 the entered password with the stored password may include comparing feature points indicated in the entered password with feature points indicated in the stored password. For instance, if the stored password was the top left corner (not labeled) of the pin board 224, then the bottom right corner (not labeled) of the pin board 224, and then the top right corner (not labeled) of the pin board 224, and the entered password was the same, then the entered password would be authenticated.

Comparing 110 the entered password with the stored password may include comparing feature points indicated in the entered password and their associated descriptors with feature points indicated in the stored password and their associated descriptors. For instance, if the stored password was entered from the location where the user 210 is shown standing in FIG. 2 and the stored password was the top left corner (not labeled) of the pin board 224, then the minute hand 225-1 of the clock 225, and then the top left corner (not labeled) of the white board 223, and the entered password was entered by the user 210 while seated in the chair 226 and the user 210 indicated the top left corner (not labeled) of the pin board 224, then the minute hand 225-1 of the clock 225, and then the top left corner (not labeled) of the white board 223 as the entered password, comparing 110 the entered password with the stored password may include using Scale-Invariant Feature Transform (SIFT), Speeded Up Robust Features (SURF), Gradient Location and Orientation Histogram (GLOH), histogram of oriented gradients (HOG), other image processing algorithms, or combinations thereof to identify feature points and/or descriptors in the entered password and the stored password and the feature points and/or descriptors may be compared using, for example, L2 norm computation and thresholding. If the feature points and/or descriptors of the entered password match the feature points and/or descriptors of the stored password, then the user 210 would be authenticated.

In some embodiments, it may be desirable to remove outliers and/or estimate a good transformation between the matched feature points and/or descriptors, to, for example, be robust against rotation, translation, scale, or combinations thereof. Thus, in some embodiments, a method, such as Random Sample Consensus (Ransac) may be applied between the entered and stored passwords.

A threshold may be selected and if the threshold is met, then the entered password is authenticated. The threshold between inliers and outliers may be ten percent. In other embodiments, the threshold may be between about one percent and about twenty percent, between about five percent and about twenty five percent, between ten percent and about fifty percent.

The threshold may be an acceptable distance from an indicated feature point in the entered password and an indicated feature point in the stored password. For example, a threshold of one centimeter of pixels between the indicated feature point in the entered password and the indicated feature point in the stored password may be selected as an acceptable distance threshold. Thus, if the indicated feature point in the entered password were further away than the acceptable distance threshold, then the entered password would not be authenticated. In some embodiments, a local coordinate system may be assigned to both the stored password and the entered password to verify each threshold (e.g., the acceptable distance from the stored feature point).

The following is a further example of a method for authenticating a user. The user may position an imaging device (e.g., the handheld imaging device 230-1 and/or the wearable imaging device 230-2) within the environment in a first position and the imaging device may record data about the environment. The environment may include the chair 226 from FIG. 2. The imaging device may record 102 data about the chair 226, such as the various features of the chair including, the chair back 226-1, the seat 226-2, the arms 226-3, the arm rests 226-4, the legs 226-5, and the wheels 226-6. For example, the imaging device may record feature points from the various chair features (e.g., corners, intersections, and/or other feature points). The imaging device may store 104 one or more user interactions with the chair 226 as a stored password. For example, the user may touch on a display and/or gesture toward a feature of the chair 226 rather than at a feature point. For example, the user may touch and/or gesture toward the front of the seat chair back 226-1, the top of the seat 226-2, and the top of the right arm rest 226-4, while the chair is oriented as shown. The imaging device may receive 106 data about the environment including data about the chair 226. In this example, the chair may have been moved (e.g., to a different location and/or a different orientation). The imaging device may receive data about the chair 226. If the rear of the chair back 226-1 were facing the user, the user may be initially unable to touch and/or gesture toward the front of the chair back 226-1 without repositioning the imaging device (e.g., moving the imaging device so that it can receive data about the front of the chair back 226-1) and/or the chair 226. When the imaging device and/or the chair 226 is repositioned, the imaging device may receive 106 data about the chair 226 such that the user may interact with the chair. The user may enter 108 a password. For example, the user may touch and/or gesture toward the front of the chair back 226-1, the top of the seat 226-2, and the top of the right arm rest 226-4. The imaging device may compare 110 the stored password to the entered password. Since the user touched and/or gestured toward the same features of the chair, the entered password would be authenticated. The authentication process may be similar to the authentication described above.

After the entered password is authenticated, then a login script may be initialized. The login script may include what level of access may be granted to a user. In some embodiments, if only a portion of the entered password matches a portion of the stored password, a lower level of security may be granted to the user. For example, if the stored password was the top left corner (not labeled) of the pin board 224, then the minute hand 225-1 of the clock 225, and then the top left corner (not labeled) of the white board 223, but the entered password were only the top left corner (not labeled) of the pin board 224 and then the minute hand 225-1 of the clock 225, within any acceptable thresholds (e.g., within an acceptable distance threshold and/or an inlier/outlier ratio threshold), then the user may be granted a lower level of access than if the user entered the full password. In another example, if the entered password were only the minute hand 225-1 of the clock 225 and the top left corner of the pin board 224 the same, a higher, or a lower level of security may be granted to the user.

Examples of access granted based on a partial password match may include only granting access to certain data and/or applications. For instance, if the user were in a home kitchen and the first part of the stored password were a cookbook (or a feature point thereof), then if a user enters the cookbook (or a feature point thereof) as a partial password, then the user may only be granted access to a recipe application. Where if the user were to have entered the entire stored password, which included the cookbook (or a feature point thereof), the user would be granted access to the recipe application and one or more additional applications and/or data.

Access to certain data and/or applications may be restricted based on a user's location. For example, a user may only access their bank account in specified areas, such as the user's office (e.g., work office and/or home office). Access would only be granted by determining that the user is in that room. Thus, if the imaging device recognizes one or more environmental features in an environment as being in one of the specified areas and the user enters an authenticated password, access to the restricted data and/or applications. For instance, if the user has specified a home office as a specified area for accessing work files and the user has a stored password for their home office, if the imaging device recognizes that the user is in the home office (e.g., by recognizing environmental features of the home office) and the user enters a password that is authenticated for the home office (e.g., the entered password matches within a threshold the stored password), then the user would be granted access to their work files.

One or more embodiments of methods for authenticating a user may perform a login script based on the location of the user. For example, an imaging device may include GPS and/or a wireless transceiver that may be used to identify the location of the user. In the example in the kitchen above, the imaging device may recognize that the user is in the kitchen based on the environmental features in the room (e.g., based on feature points and/or descriptors), based on a GPS position of the user, based on a wireless transceiver signal received, other location recognition methods, or combinations thereof.

In some embodiments, the user may store a password in a first room and then enter a password in a second room. For instance, the first room and the second room may include similar environmental features, which may include feature points and/or descriptors. In one example, the first room may be the environment 220 shown in FIG. 2 and the second room may be a different environment. The first room (e.g., environment 220) may include a first wall 221 and a second wall 222 with a white board 223 on the first wall 221 and a pin board 224 and a clock 225 on the second wall 222, and a chair 226. The second room may include a first wall and a second wall with a pin board and a clock in a similar orientation as is shown in FIG. 2. Thus, a password stored 104 in the first room (e.g., environment 220) that includes the bottom right corner (not labeled) of the white board 223, the upper left corner (not labeled) of the pin board 224, the end (not labeled) of the minute hand 225-1, and the end (not labeled) of the hour hand 225-2. For an entered password that indicates a bottom right corner of a white board, an upper left corner of a pin board, an end of a minute hand on a second clock, and an end of the hour hand on the second clock, where the positions of the right corner of the white board, the upper left corner of the pin board, the end of a minute hand on the second clock, and the end of the hour hand on the second clock are substantially close to the positions of the corresponding environmental features in the first room (e.g., within a predetermined threshold as described above), then the user may be authenticated (e.g., a login script may be run). Thus, a user may have a stored password that may work in multiple environments (e.g., rooms).

The environment 220 in FIG. 2 is merely used for ease of description. Other environments may also be used. For example, the environment may be indoor, such as a conference room (e.g., the environment 220 shown in FIG. 2), office, kitchen, family room, living room, bedroom, hallway, stairwell, other indoor area, or combinations thereof and/or may be outdoor, such as a patio, entry way, other outdoor area, or combinations thereof.

Although environmental features have been described in context of being in a certain environment, environmental features may move from environment to environment. In one example, an environmental feature may include a portable object such as a keyboard, a mouse, a picture, other portable objects, or combinations thereof. Storing 104 and/or entering 108 a password may include storing one or more user interactions with the portable object.

In a portable keyboard (e.g., a removable keyboard for a tablet computer, a wireless keyboard, a wired keyboard, or a picture of a keyboard) example, if the portable keyboard is positioned relative to the imaging device (e.g., relative to the image sensor(s)), recording 102 data about the environment may include recording data about the portable keyboard, such as the layout of the keyboard, the language of the keyboard, other features about the keyboard, or combinations thereof. Storing 104 a user interaction with the environment may include touching the display of the imaging device and/or gesturing relative to the imaging device relative to keys or other features of the portable keyboard. Receiving 106 data about the environment may include receiving data about the portable keyboard at another time where the user positions the portable keyboard relative to the imaging device. Entering 108 a password, while receiving data about the environment may include touching the display of the imaging device and/or gesturing relative to the imaging device relative to keys or other features of the portable keyboard. Then the entered password may be compared 110 with the stored password.

The preceding discussion refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Further, the methods may be practiced by a computer system that includes an imaging device, such as handheld imaging device 230-1, wearable imaging device 230-2, an imaging device directly or otherwise connected to the computer system. The computer system may also include one or more processors and computer-readable media such as computer memory. In particular, the computer memory may store computer-executable instructions that when executed by one or more processors cause various functions to be performed, such as the acts recited in the embodiments described herein.

Where doing so would not conflict with a description of a Figure herein, any act, component, information, or other element described herein may replace or be combined with other act, component, information, or other element described in conjunction with a description of any other Figure described herein. Thus, the descriptions any Figures herein is hereby incorporated by reference into the description of any other Figure herein. Such that, for example, the act (302) of registering a notification device, described in FIG. 5, may be incorporated into the method 200. In another example, the user input module 518 of FIG. 7 may be incorporated into the auxiliary alarm communication device 700 of FIG. 9. In a further example, customizing settings for a notification device (act 401) of FIG. 6 may be incorporated into the method 600 for communicating an auxiliary alarm of FIG. 8. Such that, unless expressly indicated otherwise, any act, component, information, or other element described herein may be claimed in conjunction with any other act, component, information, or other element described herein and such potential combination is hereby explicitly supported by this incorporation.

Embodiments of the present disclosure may comprise or utilize a special purpose or general-purpose computer including computer hardware, as discussed in greater detail below. Embodiments within the scope of the present disclosure also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present disclosure may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for authenticating a user, comprising:
at a first time, recording first data about an environment;
storing a user interaction with the environment as a stored password;
at a second time, receiving second data about the environment through an image sensor;
while receiving the second data about the environment, entering a password; and
comparing the entered password with the stored password.

2. The method of claim 1, wherein receiving the first data or the second data about the environment includes recording environmental features.

3. The method of claim 2, wherein the environmental features include feature points from the environment.

4. The method of claim 3, wherein the environmental features include feature points from the environment.

5. The method of claim 1, wherein receiving the first data or the second data about the environment includes recording video about the environment.

6. The method of claim 1, wherein receiving the first data or the second data about the environment through an image sensor includes receiving the first data or the second data about environmental features over a period of time.

7. The method of claim 1, wherein the image sensor is one or more of a video camera, an infrared sensor, or a depth camera.

8. The method of claim 1, wherein storing a user interaction with the environment as a stored password includes indicating an environmental feature.

9. The method of claim 8, wherein indicating an environmental feature includes tapping on a display of an imaging device while recording the first data or the second data about the environment.

10. The method of claim 8, wherein indicating an environmental feature of the environment includes gesturing toward the environmental feature.

11. The method of claim 1, wherein comparing the entered password with the stored password includes comparing a portion of the entered password with a portion of the stored password.

12. The method of claim 11, further comprising authenticating the user if the portion of the entered password matches the portion of the stored password.

13. The method of claim 1, further comprises authenticating the user if the entered password matches the stored password.

14. The method of claim 13, further comprises authenticating the user if the entered password matches the stored password within a selected threshold.

15. The method of claim 1, wherein the user interaction is associated with the first data.

16. A method for authenticating a user, comprising:
at a first time, recording one or more feature points and descriptors in an environment;
while recording one or more feature points and descriptors in the environment, storing a user interaction with the environment relative to the recorded one or more feature points and descriptors as a stored password;
at a second time, receiving one or more feature points and descriptors in the environment through an image sensor;
while receiving one or more feature points and descriptors in the environment, entering a password relative to the received one or more feature points and descriptors in the environment; and
comparing the one or more feature points and descriptors in the entered password with the one or more feature points and descriptors in the stored password.

17. An imaging device for authenticating a user, comprising:
a processor;
an image sensor in electronic communication with the processor;
memory in electronic communication with the processor with instructions executable by the processor to:
at a first time, record first data about an environment;
store a user interaction with the environment as a stored password;
at a second time, receive second data about the environment through an image sensor;
while receiving the second data about the environment, receive an entered password; and
comparing the entered password with the stored password.

18. The imaging device of 17, wherein the imaging device is a wearable imaging device.

19. The imaging device of 17, wherein the imaging device is a handheld imaging device.

20. The imaging device of 17, wherein recording the first data or the second data about an environment at the first time or the second time includes using Scale-Invariant Feature Transform (SIFT), Speeded Up Robust Features (SURF), Gradient Location and Orientation Histogram (GLOH), histogram of oriented gradients (HOG) to identify feature points in the environment.

21. The imaging device of 20, wherein comparing the entered password with the stored password includes using L2 norm computation to compare feature points in the entered password with feature points in the stored password.

22. The imaging device of claim 17, wherein the user interaction is associated with the first data.
